(19) United States
(12) Patent Application Publication
(10) Pub. No.: US 2004/0021888 A1
(43) Pub. Date: Feb. 5, 2004

(54) Office business device incorporating one-touch operation method

(76) Inventor: Chin Chi Chang, Taipei (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/207,239

(22) Filed: Jul. 30, 2002

(51) Int. Cl. H04N 1/00; G06F 15/00

(52) U.S. Cl. 358/1.13; 358/400; 358/468

(57) ABSTRACT

An office business device and a one-touch operation method are provided. The office business device incorporating the one-touch operation method includes a memory, a plurality of function keys, and a one-touch key. The function keys having predefined functions generate a plurality of setting parameters, which are stored in the memory. When an execution key is pressed, setting parameters stored in the memory are defined as one operation procedure. When the one-touch key is pressed, the setting parameters of previous operation procedures are read for.

### BACKGROUND OF THE INVENTION

1. Field of the Invention

The present invention relates to an office business device incorporating with a one-touch key operation method, and, more particularly, to a office business device having special one-touch keys to read the previous setting parameters of corresponding operation procedures for operation.

2. Description of Prior Arts

As shown in FIG. 1, U.S. Pat. No. 5,208,683 discloses a facsimile apparatus, which includes a display area 1a. Ten numeric keys (0˜9) 11a, a plurality of one-touch keys 12a, a quick dial key 13a, an image quality selection key 14a, a density selection key 15a, two search (movement) keys 16a and 17a (e.g., an “UP” key and a “DOWN” key), and a menu key 18a are respectively arranged on the display area 1a. The menu key 18a is used for setting mode selection of the one-touch keys 12a. Each of the one-touch keys 12a relies on a registration procedure to perform a plurality of desired operation procedures. Table 1 shows an embodiment of defining the operation procedures of a one-touch key X.

TABLE 1

| Operation | Order |
|---|---|
| set as the one-touch function | 1 |
| designate a specific one-touch key (e.g., X) | 2 |
| quick dial mode | 3 |
| reduced scale number # | 4 |
| reduced scale number m | 5 |
| reduced scale number n | 6 |
| image quality (“NORMAL”) | 7 |
| UP key (“FINE”) | 8 |
| density (“LOW”) | 9 |
| “UP” key (“INTERMEDIATE”) | 10 |
| “UP” key (“HIGH”) | 11 |
| register the one-touch key | 12 |

Therefore, when the one-touch key 12a is pressed, the operation procedure is as follows:

reduced scale number=#mn;

image quality=fine; and

density=high density.

Although the one-touch keys 12a can be flexibly defined by users, too many one-touch keys 12a leads to the area occupied by these one-touch keys is larger and larger, which is not compatible with the miniaturization trend for present office business devices. Additionally, the one-touch keys 12a of a conventional office business device are usually used for reduced scale numbers. Nowadays, while adding the function key of adjustment and setting of image quality and density into the display area 1a, if there are too many one-touch keys 12a, memorization and management will become more and more difficult. This type of office business device effect is thus not very easy to be manipulated even adopting the hotkey concept used in keyboard. Because it is only necessary to attach icon labels near the hotkeys for different operation procedures in the keyboard; however, in the office business device, tagging icon labels for these one-touch keys 12a is not as indicative as their counterparts on the keyboard.

Besides, when operating an office business device, it is necessary to repeat previous steps and if some inadvertent mistakes occurs while pressing function keys, the user thus needs to press function keys in a specific order again.

Accordingly, the above one-touch key technique of a conventional office business device has inconvenience and drawbacks in practical use. The present invention aims to resolve the problems in the prior art.

### SUMMARY OF THE INVENTION

The primary object of the present invention is to provide an office business device incorporating a one-touch operation method, and wherein only a one-touch key is provided. When the one-touch key is pressed, corresponding setting parameters of previous operations are read to re-execute the previous operation procedures again.

Another object of the present invention is to provide an office business device incorporating a one-touch operation method therein with only one one-touch key provided, thereby occupying less area of the office business device. Moreover, the corresponding circuit is simpler and the manufacturing is easier.

To achieve the above objects, the present invention provides an office business device, which comprises a memory, a plurality of function keys, and a one-touch key. The function keys having predefined functions to generate a plurality of setting parameters, which are stored in the memory. When an execution key is pressed, setting parameters stored in the memory are defined as at least one operation procedure. When the one-touch key is pressed, the setting parameters of the previous operation procedures are read out.

The present invention also provides a one-touch operation method for an office business device having following steps of pressing the execution key to perform an operation procedure, and re-executing previous operation procedures if the one-touch key is pressed.

The various objects and advantages of the present invention will be more readily understood from the following detailed description when read in conjunction with the appended drawing, in which:

### BRIEF DESCRIPTION OF DRAWINGS

FIG. 1 is a plain view of the display area of a facsimile apparatus in the prior art;

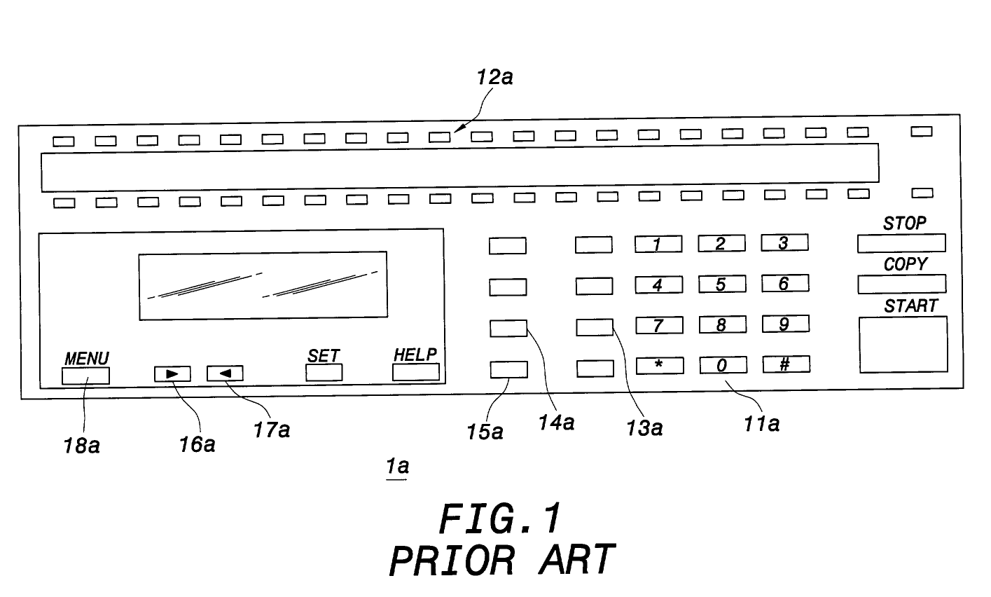

FIG. 2 is a perspective view of the present invention;

FIG. 3 is a main circuit block diagram of the present invention; and

FIG. 4 is a flowchart of the present invention.

### DETAILED DESCRIPTION OF PREFERRED EMBODIMENT

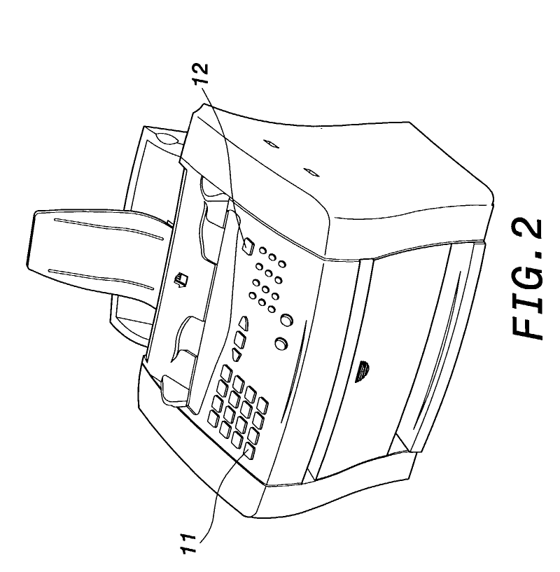

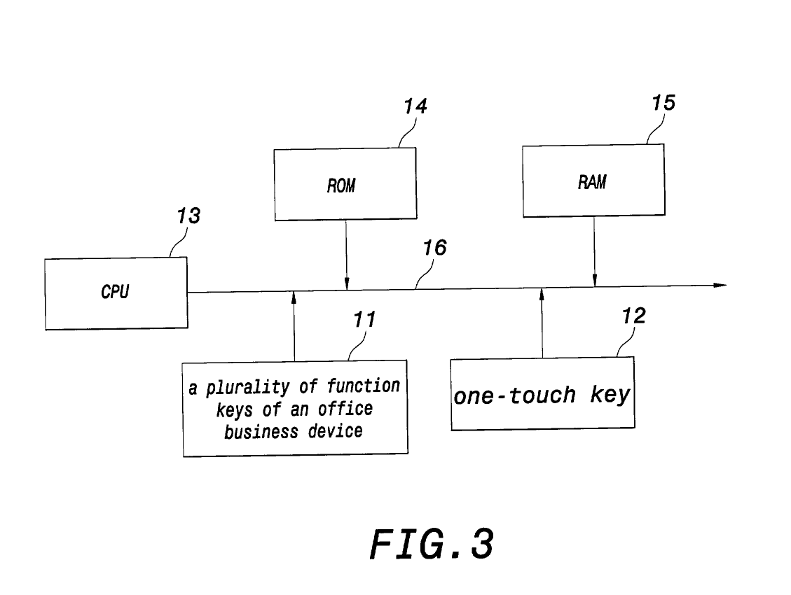

As shown in FIG. 2, an office business device 1, such as a facsimile apparatus or a multiple-function printer at least having copy and network fax functions, has a plurality of function keys 11, like numeric keys, an execution key, an “UP” key, a “DOWN” key, and so on, and a one-touch key on a display area thereof. FIG. 3 is a main circuit block diagram of the present invention, and wherein a central processing unit 13 is used to control the office business device 1, and a read-only memory is used to store several control programs. The central processing unit 13 is used to process corresponding functions generated from the function keys 11 through an interface 16, and store setting parameters corresponding to each of the function keys into a random access memory (RAM) 15. There is no doubt that the central also processing unit 13 processes the corresponding signal generated by pressing of the one-touch key 12 through the interface 16 and then reads out the setting parameters stored in the random access memory 15 corresponding to the previous operation procedures.

Besides, the random access memory 15 can be replaced with a flash memory.

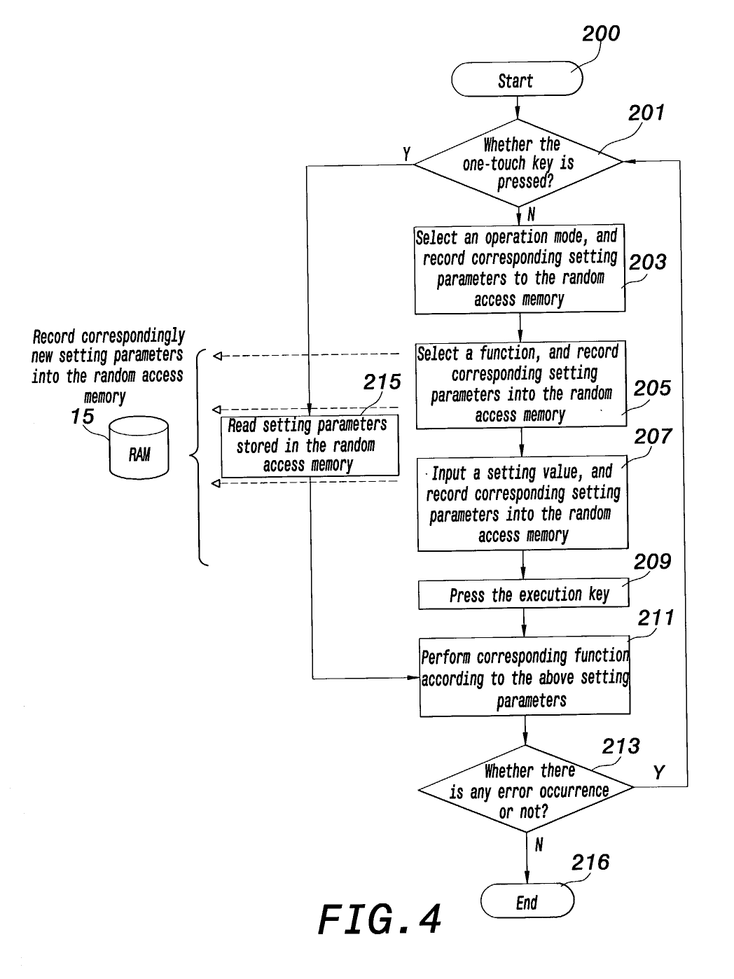

As shown in FIG. 4, the flowchart of the present invention includes following steps.

Step 201: Whether the one-touch key is pressed? If no, Step 203 is performed; otherwise go to Step 215;

Step 203: Select an operation mode, and record corresponding setting parameters to the random access memory;

Step 205: Select a function, and record corresponding setting parameters into the random access memory;

Step 207: Input a setting value, and record corresponding setting parameters into the random access memory;

Step 209: Press the execution key;

Step 211: Perform corresponding function according to the above setting parameters; and

Step 213: Whether there is any error occurrence or not? If yes, jump back to Step 201; otherwise, stop the whole operating flow as same as Step 216.

Step 215: Read setting parameters stored in the random access memory read and then jump to Step 211;

Step 216: End;

If Table 1 is defined as the previous operation procedure, once the one-touch key 12 is pressed when the operation procedure stops, the same operation procedure will be performed again.

Besides, when mistakes take place during the previous operation procedure, such as paper jammed, it is only necessary to press the one-touch key 12 to restore the original operation procedure after the error has been corrected.

Moreover, the random access memory 15 can be used to record many corresponding setting parameters of operation procedures. A user can use the “UP” and “DOWN” key to select one operation procedure when pressing the one-touch key 12.

Although the present invention has been described with reference to the preferred embodiment thereof, it will be understood that the invention is not limited to the details thereof. Various substitutions and modifications have been suggested in the foregoing description, and other will occur to those of ordinary skill in the art. Therefore, all such substitutions and modifications are intended to be embraced within the scope of the invention as defined in the appended claims.

I claim:

1. An office business device comprising:
a memory;
a plurality of function keys having predefined functions for generating a plurality of setting parameters, and wherein the setting parameters are stored into the memory so as to define an operation procedure while an execution key is pressed; and
a one-touch key pressed for reading and executing the previous operation procedure.

2. The office business device as claimed in claim 1, wherein the office business device is a facsimile apparatus or a multiple-function printer.

3. The office business device as claimed in claim 1, wherein the memory is a random access memory or a flash memory.

4. A one-touch operation method of an office business device, comprising the steps of:
(a) pressing an execution key to perform an operation procedure; and
(b) reading setting parameters for the previous operation procedure when a one-touch key is pressed.

5. The one-touch operation method as claimed in claim 4, wherein the office business device is a facsimile apparatus or a multiple-function printer.

6. The one-touch operation method as claimed in claim 4, which further comprises following steps before step (a):
selecting an operation mode and recording the corresponding setting parameters;
selecting a function and recording the corresponding setting parameters
inputting a setting value and registering the corresponding setting parameters; and
pressing the execution key.

7. The one-touch operation method as claimed in claim 4, wherein the step (b) also selects and executes the previous operation procedures.
